(19) United States
(12) Patent Application Publication
(10) Pub. No.: US 2019/0242071 A1
(43) Pub. Date: Aug. 8, 2019

(54) ARTIFICIAL TURF INFILL COMPRISING NATURAL FIBERS EMBEDDED IN A VULCANIZED PORTION

(71) Applicant: Melos GmbH, Melle (DE)

(72) Inventor: Jorg SIEKMANN, Guetersloh (DE)

(73) Assignee: Melos GmbH, Melle (DE)

(21) Appl. No.: 16/316,232

(22) PCT Filed: Jul. 21, 2017
(86) PCT No.: PCT/EP2017/068542

§ 371 Date: Jan. 8, 2019

(30) Foreign Application Priority Data
Jul. 27, 2016 (EP) 16181508.9
Dec. 15, 2016 (EP) 16204504.1

(51) Int. Cl. E01C 13/08; B32B 5/16; B32B 25/02; D06N 7/00

(52) U.S. Cl. CPC E01C 13/08; B32B 5/16; B32B 25/02; B32B 2264/0207; D06N 2205/10; B32B 2471/00; D06N 7/0063

(57) ABSTRACT

The artificial turf infill includes composite infill components. The composite infill components include natural fiber and a vulcanized portion. The natural fiber includes any one of hemp fiber, sisal fiber, cotton fiber, burlap fiber, elephant grass fiber, cellulose fiber, or combinations thereof.

### FIELD OF THE INVENTION

The invention relates to artificial turf, in particular to artificial turfs with infill and also infill for artificial turf.

### BACKGROUND AND RELATED ART

Artificial turf or artificial grass is surface that is made up of fibers which is used to replace grass. The structure of the artificial turf is designed such that the artificial turf has an appearance which resembles grass. Typically artificial turf is used as a surface for sports such as soccer, American football, rugby, tennis, golf, for playing fields, or exercise fields. Furthermore artificial turf is frequently used for landscaping applications.

Artificial turf may be manufactured using techniques for manufacturing carpets. For example artificial turf fibers which have the appearance of grass blades may be tufted or attached to a backing. Often times artificial turf infill is placed between the artificial turf fibers. Artificial turf infill is a granular material that covers the bottom portion of the artificial turf fibers. The use of artificial turf infill may have a number of advantages. For example, artificial turf infill may help the artificial turf fibers stand up straight. Artificial turf infill may also absorb impact from walking or running and provide an experience similar to being on real turf. The artificial turf infill may also help to keep the artificial turf carpet flat and in place by weighting it down.

European Patent EP 2 206 833 A1 discloses a method for producing a particulate infill material for synthetic-grass structures envisages providing a mass of thermoplastic material with a filler consisting of coconut-based material and subjecting said mass of thermoplastic material with the filler consisting of coconut-based material to granulation so as to obtain the aforesaid particulate infill material. Preferentially, the thermoplastic material is in particulate form, and the coconut-based material is in particulate form (fibrous, ground and/or shredded). The mixture obtained by mixing the thermoplastic material and the coconut-based material is preferentially heated in order to bring about softening of the thermoplastic material with the corresponding formation of a matrix of thermoplastic material that incorporates the coconut-based material as filler.

### SUMMARY

The invention provides for an artificial turf, a method, and an artificial turf infill in the independent claims. Embodiments are given in the dependent claims.

In one aspect the invention provides for an artificial turf comprising an artificial turf infill. The artificial turf infill comprises composite infill components. The composite infill components comprise natural fiber and a vulcanized portion. The natural fiber is at least partially embedded in the vulcanized portion. The combination of the natural fiber and the vulcanized portion in the artificial turf infill may offer several advantages. One potential advance is that the natural fiber may reduce the cost of the artificial turf infill. Natural fibers is a suitable infill material and can be used to reduce the amount of the vulcanized portion that is used.

The natural fiber comprises any one of the following: hemp fiber, sisal fiber, cotton fiber, burlap fiber, elephant grass fiber, cellulose fiber, and combinations thereof.

Having the natural fiber embedded within the vulcanized portion may have the advantage that the natural fiber does not become unmixed with the rest of the artificial turf infill. For example if natural fiber and the vulcanized portion were mixed loosely together over a period of time and being exposed to rain and water for example the natural fiber may have a tendency to go on top of the vulcanized portion and separate out. Having the natural fiber at least partially embedded in the vulcanized portion may prevent this. Another potential advantage is that natural fiber has a relatively high specific heat in comparison to other materials which are commonly used for artificial turf infill. If the artificial turf is exposed to warm air or to sunlight the use of the natural fiber may help to reduce heating of the artificial turf and the artificial turf infill overall. This may make for a safer and more pleasant playing surface. Another potential advantage is that natural fiber has high water absorbance and therefore the capacity to hold large amounts of water. Before a game is played on the artificial turf it may be possible to spray or sprinkle water onto the artificial turf. During the period of the game water which is contained in the natural fiber may slowly evaporate helping to keep the entire artificial turf surface cool during a game.

Natural fiber can comprise fibers. Each of these fibers (or each of some of these fibers) is only partially embedded in the vulcanized portion. The fiber being only partially embedded in the vulcanized portion can be effectively divided into two portions in the longitudinal direction of the fiber, wherein one portion of the fiber is embedded in the vulcanized portion and another portion of the fiber is not embedded in the vulcanized portion. In other words the other portion protrudes from the vulcanized portion. As it is customary in the industry the other portion protruding from the vulcanized portion is called a dangling end. At least some of the portions protruding from the vulcanized portions can be longer than their respective portions embedded in the vulcanized portion.

Portions of fibers which are not embedded in the vulcanized portions can facilitate water absorption, because they a fully exposed to water or moister. Water absorbed by the dangling end of the fiber which is not embedded in the vulcanized portion can further spread into the rest of the fiber which is embedded in the vulcanized portion e.g. due to capillary effect. Thus the dangling ends of the fibers can facilitated water absorption. The dangling end can further facilitate water evaporation from the fiber as well because entire surface of the dangling end is exposed to air. Moreover the embedded portion of the fiber can serve as a water reservoir for the dangling end portion of the fiber.

In another embodiment, a weight percentage of the fibers being only partially embedded in the vulcanized portion in the overall weight of the natural fiber comprising the fibers being only partially embedded in the vulcanized portion and fibers being fully embedded in the vulcanized portion is at least 10%.

In another embodiment, a weight percentage of the fibers being only partially embedded in the vulcanized portion in the overall weight of the natural fiber comprising the fibers being only partially embedded in the vulcanized portion and fibers being fully embedded in the vulcanized portion is at least 5%.

In another embodiment, the natural fiber consists any one of the following: hemp fiber, sisal fiber, cotton fiber, burlap fiber, elephant grass fiber, cellulose fiber, and combinations thereof.

In another embodiment, the composite infill components comprise 10% to 40% of the natural fiber by weight.

The artificial turf of any one of the preceding claims, wherein the composite infill components comprise 15% to 25% of the natural fiber by weight.

The artificial turf of any one of the preceding claims, wherein the composite infill components comprise 17% to 23% of the natural fiber by weight.

In another embodiment the vulcanized portion comprises a vulcanization of ethylene propylene diene monomer (M-class) rubber (EPDM) granulate, mineral oil, and sulfur. A mineral oil as used herein encompasses a transparent, colorless oil composed mainly of alkanes and cycloalkanes.

A potential advantage is that the natural fibers listed are compatible with vulcanization processes. For example these natural fibers are able to survive a vulcanization process at 180° C. Additionally, these natural fibers have a relatively low lignin content. This enables it to be compatible with the vulcanization process. Other fibers such as wool or coconut may have a high lignin content. They may have an adverse reaction during the vulcanization process which causes them to have a very strong odor. An advantage to using a vulcanization process is that the bond between the natural fiber and the vulcanized portion is very strong. Wool and/or coconut fibers could be attached to an infill material, but they may be less durable than natural fibers embedded in the vulcanized portion.

The use of hemp may also be beneficial because hemp is naturally resistant to fungi in comparison with coconut fibers. Hemp also has the benefit of being very skin friendly. Hemp is less abrasive and/or prickly than many other natural fibers such as wood chips or coconut fibers.

The use of hemp as an infill material may also be beneficial because it has superior damping and shock absorption properties. A player who falls on an artificial turf with an infill according to an embodiment may in some cases be less likely to be hurt than if the player fell on an artificial turf that had a predominantly coconut fiber based infill.

In another embodiment the vulcanization further comprises a filler material. The use of a filler material may be beneficial because it may be useful for reducing the cost of using the EPDM granulate.

In another embodiment the filler material comprises any one of the following: kaolinite, chalk, and combinations thereof. The use of these materials may be beneficial because they are both compatible with the vulcanization process and also when natural fibers are present.

In another embodiment the composite infill component comprises 15-25% of the EPDM granulate by weight.

In another embodiment the composite infill components comprise 23-26% of the mineral oil by weight.

In another embodiment the composite infill components comprise 50-55% of the filler material by weight.

In another embodiment the vulcanized portion has a jagged surface. The presence of the jagged surface may be beneficial because it may help to keep the artificial turf infill in a fixed position relative to the other portions of the infill material.

In another embodiment the natural fiber has a maximum diameter of 1 mm.

In another embodiment the natural fiber has a maximum length of 0.3 cm.

In another embodiment the natural fiber has a maximum length of 0.5 cm.

In another embodiment the natural fiber has a maximum length of 1 cm.

In another embodiment the vulcanized portion further comprises a polyethylene based dye and a compatibilizer. The use of the polyethylene based dye with the compatibilizer may be beneficial because polyethylene based dyes may be able to impart a lifelike appearance or color on the artificial turf infill.

The vulcanized portion further comprises any one of the following: a vulcanization catalyst and mercaptobenzothiazole. The use of either of these components in the vulcanized portion may increase the quality of the resulting artificial turf infill.

In another embodiment the vulcanized portion comprises cavities formed by ripping natural fibers from the vulcanized portion. This may be beneficial because it may make the surface of the vulcanized portion more irregular and enable it to interlock with other portions of the artificial turf infill better and/or also to have a larger surface area for containing water when it has been wetted to keep it cool.

In another embodiment the vulcanized portion has a diameter between 0.5 and 5 mm.

In another embodiment the vulcanized portion has a diameter between 0.7 and 4 mm.

In another embodiment the vulcanized portion has a diameter between 0.8 and 3 mm.

In another embodiment the artificial turf comprises an artificial turf carpet.

In another embodiment the artificial turf further comprises a sprinkler system. The inclusion of a sprinkler system may be beneficial because it may provide for a means of conveniently wetting an artificial turf surface with water. The natural fibers may retain some of the water and may slowly evaporate it thus keeping the artificial turf cool even when it is in strong sunlight.

In another embodiment, the natural fiber comprises fibers with a length between 0.01 mm and 5 mm long.

In another embodiment, the natural fiber comprises fibers with a length between 0.01 and 1.5 mm long.

In another aspect the invention provides for a method of at least partially manufacturing an artificial turf surface. The method comprises mixing multiple components to form a master batch. The multiple components comprise EPDM granulate, natural fibers, sulfur, and mineral oil. The method further comprises forming the master batch into a plate. A plate as used herein encompasses a master batch that has been compressed. The method further comprises vulcanizing the plate. The method further comprises granulating the plate to provide the artificial turf infill. During the granulation process the vulcanized plate may be ripped into smaller pieces that form the vulcanized portion. When the plate was vulcanized the natural fibers were dispersed randomly within the vulcanized plate. By granulating some of the natural fibers will be ripped from a portion of the vulcanized portion. In the majority of the cases at least a portion of the natural fiber will be attached to a vulcanized portion.

The method further comprises installing an artificial turf carpet on a surface. The artificial turf carpet comprises a pile. The method further comprises spreading the artificial turf infill within the pile.

In another embodiment the method further comprises milling the natural fibers in the mineral oil before adding the natural fibers to the master batch. The milling of the natural fibers in the mineral oil may provide several advantages. A large advantage is that the natural fibers are less likely to be ground into very small portions such as dust. Milling them in the mineral oil therefore helps to produce an artificial turf infill with more uniform and intact natural fiber that has been reduced in size. The mineral oil is also the same mineral oil which may be used in producing the vulcanized portion. The mineral oil therefore fulfills two requirements in this one manufacturing process. The method further comprises adding any one of the following to the master batch: a filler material, a dye dissolved in polyethylene, a polyethylene compatibilizer, a vulcanization catalyst and/or mercaptobenzothiazole, and combinations thereof.

In another embodiment the granulation of the plate comprises grinding, cutting and/or shredding of the plate.

In another embodiment the artificial turf infill comprises composite infill components. The composite infill components comprise natural fibers and a vulcanized portion. The natural fibers are at least partially embedded in the vulcanized portion. The vulcanized portion comprises a vulcanization of EPDM granulate, mineral oil, and sulfur.

It is understood that one or more of the aforementioned embodiments of the invention may be combined as long as the combined embodiments are not mutually exclusive.

### BRIEF DESCRIPTION OF THE DRAWINGS

In the following embodiments of the invention are explained in greater detail, by way of example only, making reference to the drawings in which:

FIG. 1 illustrates an example of a composite infill component;

FIG. 2 illustrates a further example of a composite infill component;

FIG. 3 illustrates a further example of a composite infill component;

FIG. 4 is a photograph of a further example of a composite infill component;

FIG. 5 depicts a size distribution chart for the composite infill component of FIG. 4;

FIG. 6 depicts a chart illustrated an increase in water absorption and a temperature decrease for the composite infill of FIG. 5;

FIG. 7 illustrates an artificial turf carpet being used for manufacture of a artificial turf;

FIG. 8 illustrates a artificial turf;

FIG. 9 shows a flow chart which illustrates a method of manufacturing a composite infill component; and

FIG. 10 illustrates an artificial turf with an automatic sprinkler system.

### DETAILED DESCRIPTION

Like numbered elements in these figures are either equivalent elements or perform the same function. Elements which have been discussed previously will not necessarily be discussed in later figures if the function is equivalent. FIGS. 1-4 illustrate several examples of a composite infill component for artificial turf. FIG. 1 shows a first example. There is a natural fiber 102 that is partially embedded in a vulcanized portion 104. The views in FIGS. 1-3 are cross-sectional views and the view in FIG. 4 is a photograph. In some examples the composite infill components are made by shredding or grinding a larger vulcanized plate of material. Some of the fibers can be ripped from portions of the composite infill components when they are manufactured. In FIG. 1 there is a cavity 108 that has been formed by pulling a natural fiber from the vulcanized portion 104 during manufacture. The surface of the vulcanized portion 104 may also be rough 106 due to the manufacturing process.

In FIG. 1 the natural fiber 102 has a volume that is several times smaller than the vulcanized portion 104. The fiber 102 is only partially embedded in the vulcanized portion 104. The fiber 102 has two portions 102a and 102b. The border between these portions depicted by a dashed line illustrates splitting of the fiber 102. The portion 102b is fully embedded in the vulcanized portion 104. The portion 102a is not embedded in the vulcanized portion 104. In other words, the portion 102a is a dangling end of the fiber 102. A surface separating the portion 102b from the portion 102a is substantially orthogonal to the longitudinal axis of the fiber 102.

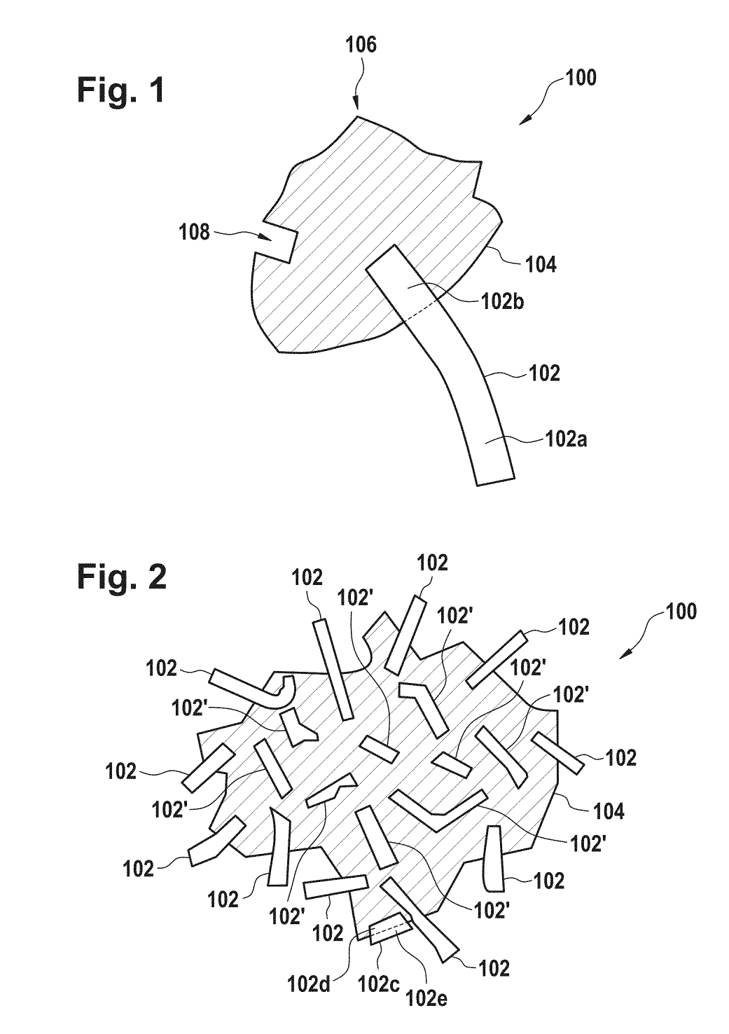

FIG. 2 shows a further example where the vulcanized portion 104 is much larger than the natural fibers 102, 102′. On the surface it can be seen that there are a number of natural fibers 102 that are only partially embedded. However the vulcanized portion 104 is so large that there are some fibers 102′ which are totally embedded in the vulcanized portion 104. An advantage of using the natural fibers 102, 102′ is that they absorb water. This may help to make the artificial turf surface seem more realistic and softer and may also have the effect of storing water to reduce the temperature of the playing surface. The fibers which are totally embedded in the vulcanized portion 104 are not able to absorb water, however the cost of natural fiber is considerably less than the cost of the vulcanized portion. The natural fiber that is embedded 102′ may serve to reduce the cost of the composite infill components.

The fibers having dangling ends can facilitate water absorption and evaporation. The dangling end of a fiber can absorb water or moister in an effective way because entire surface area (or substantial portion of a surface area) of the dangling end can be in full contact with water or moister. The same is valid for evaporation of water, because entire surface area (or substantial portion of the surface area) of the dangling end is in contact with air. Moreover the embedded portions of the fibers having dangling ends can act as reservoirs of water, e.g. due to capillary effect.

FIG. 2 shows yet another example how a partially embedded fiber can be split into two portions. In contrast to the fiber 102 depicted on FIG. 1, the fiber 102c on FIG. 2 is split longitudinally into two portions. The spilling is depicted by the dashed line on FIG. 2 merely for illustrative purposes. A portion 102e of the fiber 102c is embedded in the vulcanized portion, while a portion 102d of the fiber 102c is protruding from the vulcanized portion.

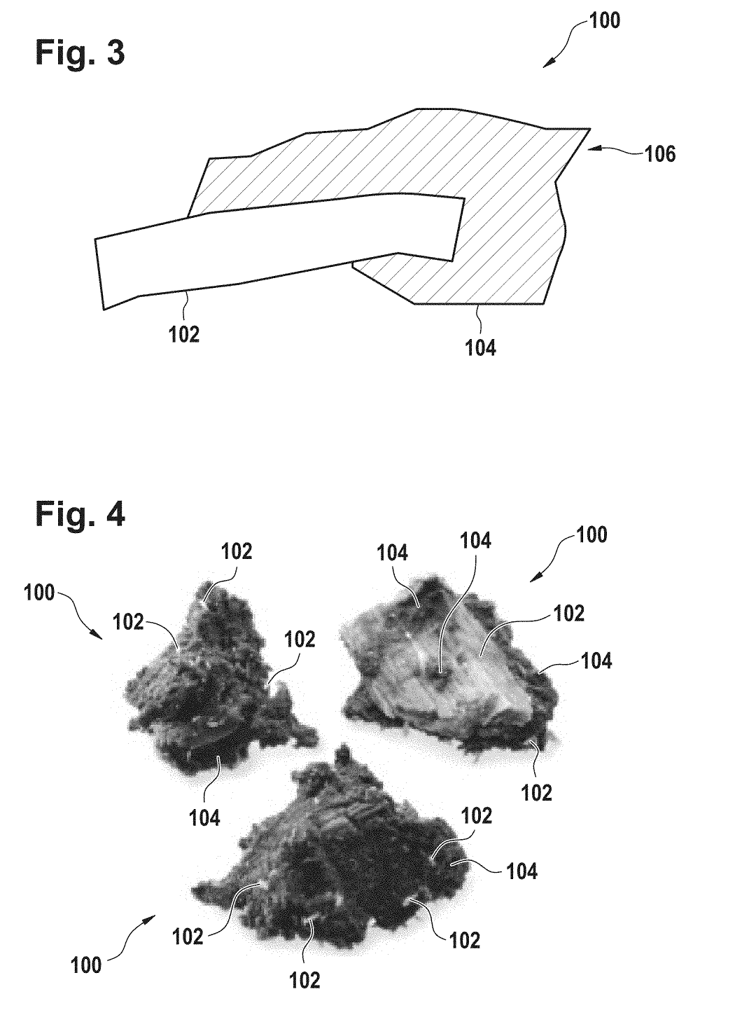

FIG. 3 shows an example where the natural fiber 102 has a volume that is comparable to the vulcanized portion 104.

FIG. 4 shows a photograph of three composite infill components 100. The composite component in the upper right corner corresponds to the situation in FIG. 3. The vulcanized portion 104 has a volume which is comparable to the volume of the embedded natural fiber 102. The other composite infill components 102 are shown as having much smaller natural fibers 102 that are partially exposed from the surface of the vulcanized portion 104. The examples which are shown in the photographs of FIG. 4 is an example where the composite infill components are made from a vulcanized EPDM and 20% natural fibers.

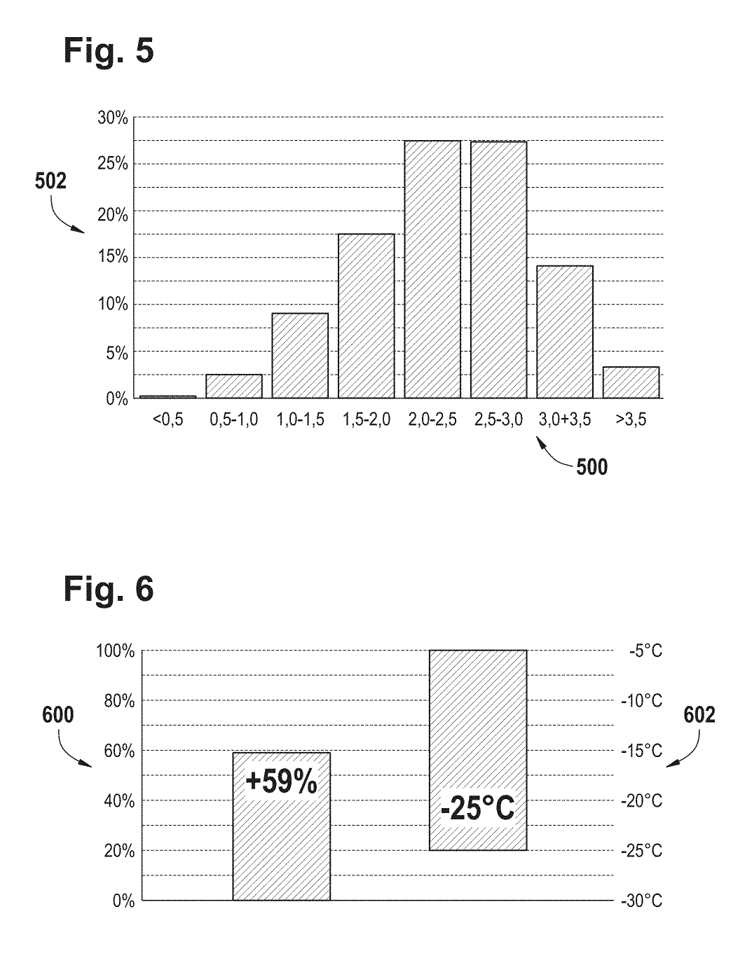

FIG. 5 shows a sieve curve that illustrates the size of the composite infill components manufactured as they are depicted in FIG. 4. The x-axis shows the size distribution of the particles in millimeters and the y-axis shows the percentage of the total number of particles by wt. It can be seen that the majority of the composite infill components have a sieve size of between 2 and 2.5 mm.

FIG. 6 compares several properties of the composite infill component depicted in FIG. 4 in comparison to composite infill manufactured from EPDM alone. FIG. 6 illustrates the increase in the ability of the composite infill component to absorb water and thereby reduce the temperature of an artificial turf surface exposed to sunlight. FIG. 6 illustrates that the addition of the 20% natural fiber to the infill component increase the water absorption by 59%. Before an artificial turf surface is used for playing for example a game, the surface can be hosed down or made wet with sprinklers. As the sun shines on the surface the evaporation of water will serve to help cool the playing surface. During a typical day when it is sunny it can be seen that the temperature reduction is approximately 25° C. In addition to the absorbing water the use of the natural fibers also helps to reduce the temperature because the natural fibers have a comparatively large specific heat in comparison to the EPDM or the polymers that may be used for making artificial turf. The natural fibers do not heat very quickly and help to isolate other components of the artificial turf from being heated.

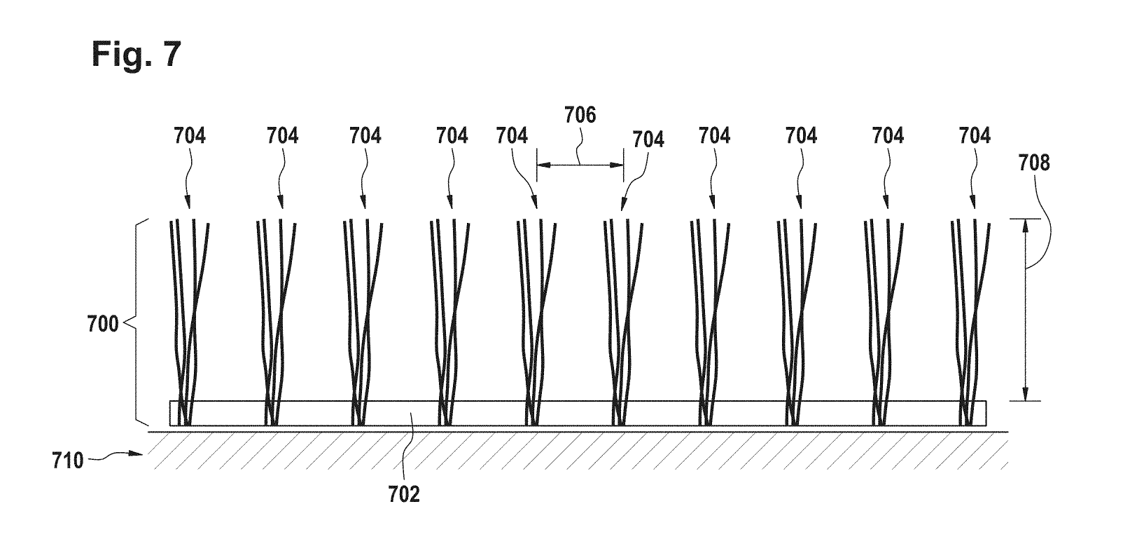

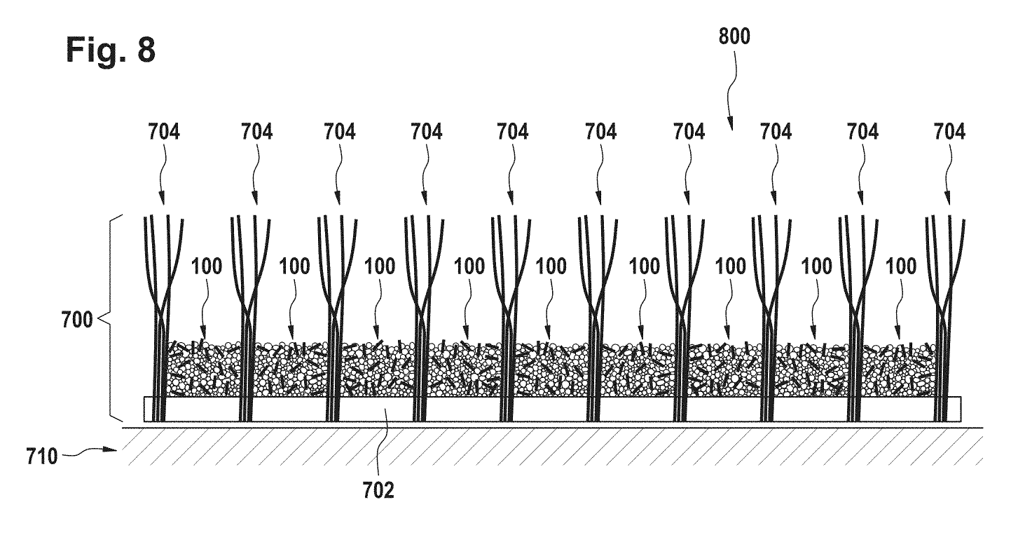

FIGS. 7 and 8 illustrate the manufacture of an artificial turf using an artificial turf carpet and artificial turf infill. In FIG. 7 an artificial turf carpet 700 can be seen. The artificial turf carpet 700 comprises a backing 702. The artificial turf carpet 700 shown in FIG. 7 is a tufted artificial turf carpet in this example. The artificial turf carpet is formed by artificial turf fiber tufts 704 that are tufted into the backing 702. The artificial turf fiber tufts 704 are tufted in rows. There is row spacing 706 between adjacent rows of tufts. The artificial turf fiber tufts 704 also extent a distance above the backing 702. The distance that the fibers 704 extend above the backing 702 is the pile height 708. In FIG. 7 it can be seen that the artificial turf carpet 700 has been installed by placing or attaching it to the ground 710 or a floor.

To manufacture the artificial turf the artificial turf 800 a infill made up of composite infill components 101 such as is shown in FIGS. 1 through 4 that are spread out on the surface and distributed between the artificial turf fiber tufts 704. FIG. 8 shows the artificial turf carpet 700 after artificial turf infill 802 has been spread out and distributed between the artificial turf fiber tufts 704. The artificial turf infill 802 comprises the composite infill components 100.

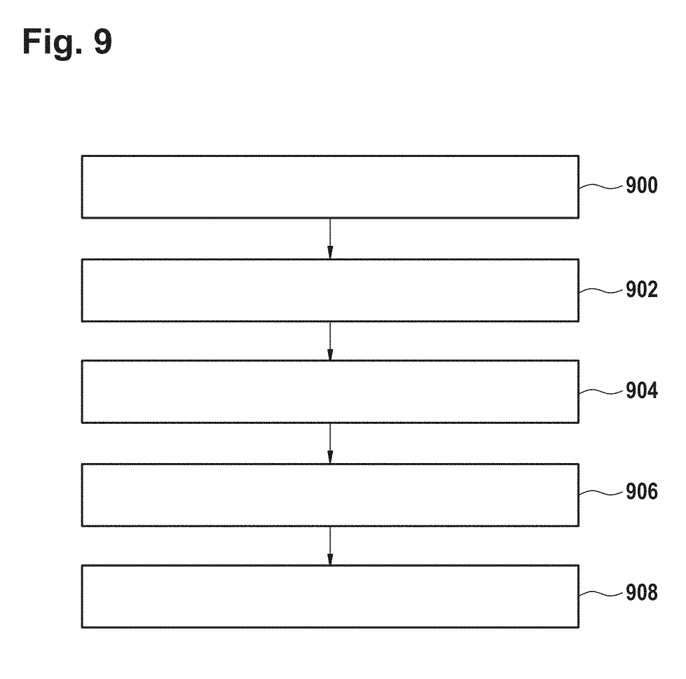

FIG. 9 illustrates a method of manufacturing composite infill components for artificial turf infill. First in step 900 the natural fiber is optionally combined with the mineral oil and is then milled. The milling of the natural fiber with the mineral oil may be beneficial because it may prevent the natural fiber from producing a large amount of dust. Next, in step 902 the multiple components are mixed to form a master batch. The master batch may, for example, comprise for example EPDM granulate, natural fibers, sulfur, and mineral oil. After the master batch has been mixed the master batch may be formed 904 into a solid form. After being formed into a solid form the solid form may be vulcanized 906. Steps 904 and 906 may in some cases be performed at the same time. The Master batch could for example be placed into a plate vulcanizer and compressed. The master batch could also be put through an extruder that vulcanizes the master batch as it is extruded.

After the solid form has been vulcanized it is then granulated 908. For example the solid form may be cut, shredded or ground to provide the artificial turf infill. The artificial turf infill may be then used to manufacture an artificial turf as it is illustrated in FIGS. 7 and 8.

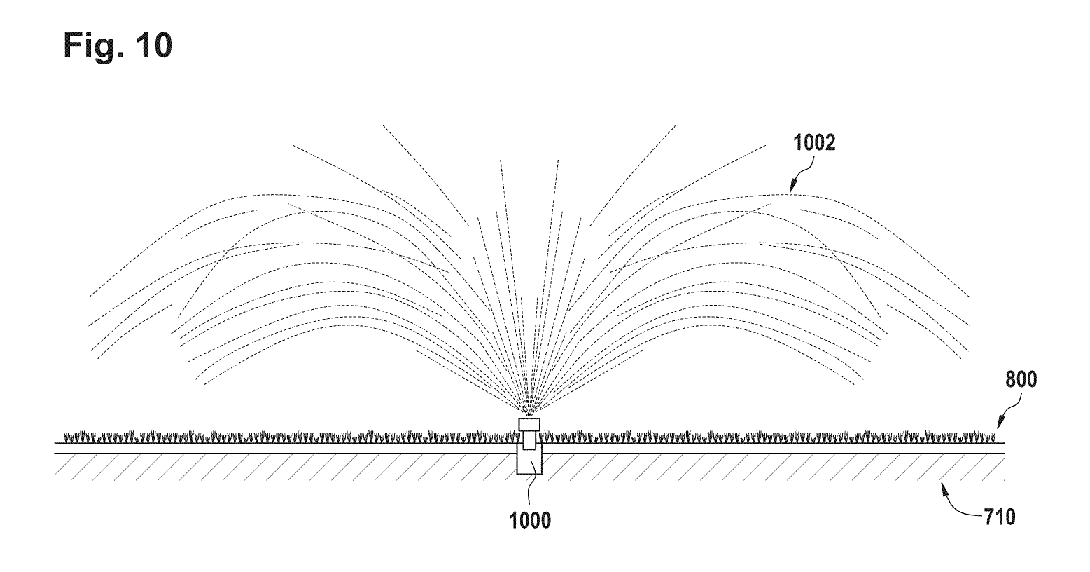

FIG. 10 shows a further example of the artificial turf 800. In this example an automatic sprinkler system 1000 has been integrated into the artificial turf 800. The sprinkler 1000 is depicted as spraying water 1002 on an upper surface of the artificial turf 800. The use of an artificial sprinkler may be beneficial in combination with the composite infill component that comprises both the vulcanized portion and the natural fiber. As illustrated in FIG. 6, the water may help to keep the surface of the artificial turf 700 cool.

### LIST OF REFERENCE NUMERALS

100 composite infill component
102 partially embedded natural fiber
102′ embedded natural fiber
104 vulcanized portion
106 rough surface
108 cavity
500 size in mm
502 percent of total
600 increase in water absorption
602 temperature reduction in degrees Celsius
700 artificial turf carpet
702 backing
704 artificial turf fiber tufts
706 row spacing
708 pile height
710 ground or floor
700 artificial turf
702 artificial turf infill
900 milling the natural fibers in mineral oil
902 mixing multiple components to form a mater batch
904 shaping the master batch into a solid form
906 vulcanizing the solid form
908 granulating the solid form to provide artificial turf infill
1000 sprinkler
1002 water

1. An artificial turf comprising an artificial turf infill, wherein the artificial turf infill comprises composite infill components, wherein the composite infill components comprise natural fiber and a vulcanized portion, wherein the natural fiber is at least partially embedded in the vulcanized portion, wherein the natural fiber is bonded to the vulcanized portion using a vulcanization process, wherein the natural fiber comprises any one of hemp fiber, sisal fiber, cotton fiber, burlap fiber, elephant grass fiber, cellulose fiber, or combinations thereof.

2. The artificial turf of claim 1, wherein the vulcanization further comprise a filler material.

3. The artificial turf of claim 2, wherein the filler material comprises any one of Kaolinite, chalk, or combinations thereof.

4. The artificial turf of claim 2, wherein any one of the following:
wherein the composite infill components comprise 15% to 25% of the EPDM granulate by weight;
wherein the composite infill components comprise 23% to 26% of the mineral oil by weight;
wherein the composite infill components comprise 50% to 55% of the filler material by weight; and
combinations thereof.

5. The artificial turf of claim 1, wherein the vulcanized portion has a jagged surface.

6. The artificial turf of claim 1, wherein natural fiber has a maximum length selected from any one of the following: 0.3 cm, 0.5 cm, and 1 cm.

7. The artificial turf of claim 1, wherein the vulcanized portion further comprises a poly ethylene based dye and a compatibilizer.

8. The artificial turf of claim 1, wherein the vulcanized portion further comprises a any one of a vulcanization catalyst or Mercaptobenzothiazole.

9. The artificial turf of claim 1, wherein the vulcanized portion comprises cavities formed by ripping natural fiber from the vulcanized portion.

10. The artificial turf of claim 1, wherein the vulcanized portion has a diameter between 0.5 mm and 5.0 mm.

11. The artificial turf of claim 1, wherein the artificial turf comprises an artificial turf carpet.

12. The artificial turf of claim 1, wherein the artificial turf further comprises a sprinkler system.

13. The artificial turf of claim 1, wherein the composite infill components comprise 10% to 40% of the natural fiber by weight.

14. The artificial turf of claim 1, wherein the natural fiber comprises fibers with a length between 0.01 mm and 5 mm long.

15. A method of at least partially manufacturing an artificial turf, wherein the method comprises:
mixing multiple components to form a mater batch, wherein the multiple components comprise, EPDM granulate, natural fiber, sulfur, and mineral oil, wherein the natural fiber comprises any one of hemp fiber, sisal fiber, cotton fiber, burlap fiber, elephant grass fiber, cellulose fiber, or combinations thereof;
shaping the master batch into a solid form;
vulcanizing the solid form; and
granulating the solid form to provide artificial turf infill.

16. The method of claim 15, wherein the method further comprises:
installing an artificial turf carpet on a surface, wherein the artificial turf carpet comprises a pile; and
spreading the artificial turf infill within the pile.

17. The method of claim 15, wherein the method further comprises milling the natural fibers in the mineral oil before adding the natural fiber to the master batch.

18. The method of claim 15, wherein the method further comprises adding any one of the following to the master batch:
filler material;
dye dissolved in PE;
PE compatibilizer;
a vulcanization catalyst and/or Mercaptobenzothiazole; and
combinations thereof.

19. The method of claim 18, wherein the solid form is a plate, wherein granulation of the plate comprises grinding, cutting, and/or shredding of the plate.

20. An artificial turf infill for use as infill for an artificial turf carpet; wherein the artificial turf infill comprises composite infill components, wherein the composite infill components comprise natural fiber and a vulcanized portion, wherein the natural fiber is at least partially embedded in the vulcanized portion, wherein the natural fiber is bonded to the vulcanized portion using a vulcanization process, wherein the natural fiber comprises any one of hemp fiber, sisal fiber, cotton fiber, burlap fiber, elephant grass fiber, cellulose fiber, or combinations thereof.

21. The artificial turf infill of claim 20, wherein the natural fiber is at least partially embedded in the vulcanized portion.

22. The artificial turf infill of claim 20, wherein some of the natural fiber is only partially embedded in the vulcanized portion.

23. The artificial turf infill of claim 20, wherein the natural fiber comprises fibers, wherein the fibers comprise first portions being embedded in the vulcanized portion.

24. The artificial turf infill of claim 23, wherein the fibers comprise second portions protruding from the vulcanized portion.

25. The artificial turf infill of claim 24, wherein at least some of the second portions are longer than their respective first portions.

26. The artificial turf infill of claim 23, wherein a weight percentage of the fibers in the overall weight of the natural fiber is at least 10%.

27. The artificial turf infill of claim 23, wherein a weight percentage of the fibers in the overall weight of the natural fiber is at least 5%.

28. The artificial turf infill of claim 20, wherein the natural fiber comprises fibers having dangling ends.
